(19) United States
(12) Patent Application Publication
(10) Pub. No.: US 2021/0016433 A1
(43) Pub. Date: Jan. 21, 2021

(54) SYSTEM AND METHOD FOR CONFIGURING AND SERVICING A ROBOTIC HOST PLATFORM

(71) Applicant: ADVANCED INTELLIGENT SYSTEMS INC., Burnaby (CA)

(72) Inventors: Farhang Bidram, West Vancouver (CA); Shahram Pourazadi, Burnaby (CA); Afshin Doustmohammadi, North Vancouver (CA)

(21) Appl. No.: 16/980,052

(22) PCT Filed: Mar. 13, 2019
(86) PCT No.: PCT/CA2019/050311

§ 371 Date: Sep. 11, 2020

Related U.S. Application Data
(60) Provisional application No. 62/642,202, filed on Mar. 13, 2018.
(60) Provisional application No. 62/802,504, filed on Feb. 7, 2019.
(60) Provisional application No. 62/804,123, filed on Feb. 11, 2019.

(51) Int. Cl. B25J 9/08; B25J 9/16; B25J 13/00; B25J 19/00; B25J 9/14

(52) U.S. Cl. CPC B25J 9/08; B25J 9/161; B25J 13/006; B25J 9/14; B25J 19/0029; B25J 19/005; B25J 9/162

(57) ABSTRACT

A robotic method and system for providing robotic functions associated with performing an automated task is disclosed. The system includes a host platform operably configured to provide at least some of the robotic functions for performing the automated task and having at least one interface operably configured to receive a modular component operable to provide additional robotic functions for performing the automated task. The system also includes a processor circuit disposed on at least one of the host platform land the modular component. The at least one interface includes a mechanical interface having mounting features that correspond to mounting features on the modular component for removably mounting the modular component, a signal interface for transmitting signals between the modular component and the host platform, and a data interface implemented on the processor circuit and operable to provide functionality for exchanging at least one of commands for performing the additional functions or data associated with the additional functions between the modular component and the processor circuit.

### RELATED APPLICATIONS

This application claims the benefit of provisional patent application 62/642,202 entitled “CUSTOMER REPLACEABLE UNIT FOR ROBOTS”, filed on Mar. 13, 2018 and incorporated herein by reference in its entirety. This application also claims the benefit of provisional patent application 62/802,504 entitled “SYSTEM AND METHOD FOR REMOTE RESTORING, ALTERING, OR IMPROVING HARDWARE FUNCTIONALITY OF A MODULAR ROBOTIC PLATFORM”, filed on Feb. 7, 2019 and incorporated herein by reference in its entirety. This application also claims the benefit of provisional patent application 62/804,123 entitled “SYSTEM AND METHOD FOR COLLABORATION OF ROBOTIC SYSTEMS FOR AUTONOMOUS RESTORING, ALTERING, OR IMPROVING OF HARDWARE FUNCTIONALITY”, filed on Feb. 11, 2019 and incorporated herein by reference in its entirety.

### BACKGROUND

### 1. Field

This disclosure relates generally to robotic system and more particularly to a robotic system including a host platform and one or more modular components received on the host platform.

### 2. Description of Related Art

Worksite automation is becoming increasingly important in many industries, such as agricultural, automotive, medical, warehousing, and aerospace industries. In many instances autonomous or non-autonomous robots may be employed to perform a variety of task on an automated or semi-automated basis. As the deployment of robotic system increases, configuration and service of the systems deployed at a worksite becomes more challenging, since in many cases specialized skills are required for personnel servicing robotic systems. When there is a failure of a robotic system, the resulting downtime may lead to workflow disruption at the worksite. Furthermore, updating and upgrading the hardware of a robotic system often requires that the unit be taken out of service for some time to perform upgrades.

There remains a need for robotic systems configured to facilitate more effective and efficient service, configuration, and upgrading.

### SUMMARY

In accordance with one disclosed aspect there is provided a robotic system for providing robotic functions associated with performing an automated task. The system includes a host platform operably configured to provide at least some of the robotic functions for performing the automated task and having at least one interface operably configured to receive a modular component, the modular component being operable to provide additional robotic functions for performing the automated task. The system also includes a processor circuit disposed on at least one of the host platform and the modular component. The at least one interface includes a mechanical interface having mounting features that correspond to mounting features on the modular component for removably mounting the modular component to the mechanical interface of the host platform, a signal interface for transmitting signals between the modular component and the host platform, and a data interface implemented on the processor circuit and operable to provide functionality for exchanging at least one of commands for performing the additional functions or data associated with the additional functions between the modular component and the processor circuit.

The signal interface may include one or more connectors that facilitate connection of signal lines for communicating between the processor circuit and the robotic system.

The electrical connector may include a signal connector portion for connecting low level electrical signals and data lines between the host platform and the modular component, and a power/drive connector portion for connecting higher current lines between the host platform and the modular component, and the signal connector portion and the power/drive connector portion may be separated to reduce effects of electromagnetic interference on the low level electrical signals and data lines.

The processor circuit may include a primary processor circuit operably configured to control functions of the host platform and the modular component, and may further include a component processor circuit disposed on the modular component and operably configured to interface with the primary processor circuit via the data interface to perform the additional robotic functions.

The primary processor circuit may be configured as a modular component and may be received at a primary processor circuit interface on the host platform.

The mechanical interface may further include a mechanical coupler for transmitting power between the host platform and the modular component.

The mechanical coupler may include at least one of a fluid coupling for transmitting hydraulic power between the host platform and the modular component, a fluid coupling for transmitting pneumatic power between the host platform and the modular component, and a drive coupler for transmitting one of a torque or a force between the host platform and the modular component.

The signal interface may include a wireless signal interface.

The data interface between the processor circuit and the modular component may be via a wireless communications link with a remotely located cloud processor, the cloud processor being operably configured to initiate act as an intermediary between the processor and the modular component.

The robotic functions provided by the host platform may be provided by components mounted directly on the host platform, the components may include at least one of a primary processor circuit operably configured to control functioning of the host platform and the at least one modular component, a main drive operably operable to position the host platform within a worksite for performing robotic tasks, an auxiliary drive operable to act as a mechanical interface for mounting a moveable modular component, and an electrical chassis for routing electrical connections between the interface and the host platform.

The modular component may include one of a plurality of modular manipulator components, each modular manipulator component having a common component interface corresponding to the host platform interface, and one of a plurality of different manipulators operably configured to perform different manipulator functions for performing the automated task.

The modular component may include at least one of a power storage device operable to provide power for operating the robotic system, a communication device operably configured for at least one of receiving data or transmitting data between the robotic system and a host controller, and a structure for receiving and supporting articles for transport within a worksite.

The modular component may include a common coupler operably configured to facilitate handling of the modular component by a manipulator of a robotic system, the robotic system having an end effector operably configured to engage the common coupler for mounting the modular component at the interface on the host platform.

The common coupler may include standardized features added to each of a plurality of different modular components to facilitate handling by single standardized end effector of the robotic system.

The manipulator may be associated with one of another robotic system other than the robotic system having the modular component being mounted, the other robotic system being operably configured to handle and install the modular component, and a functioning manipulator of the robotic system having the modular component being mounted, the functioning manipulator being operable to handle and install the modular component.

The interface may include a standardized interface associated with a group of modular components operably configured to provide similar additional robotic functions.

The signal interface may include a connector standardized for connection to modular components that provide the similar additional robotic functions.

In accordance with another disclosed aspect there is provided a method of operating a robotic system for performing an automated task, the robotic system including a host platform operably configured to provide at least some of the robotic functions for performing the automated task and having at least one interface operably configured to receive a modular component, the modular component being operable to provide additional robotic functions for performing the automated task. The method involves providing a modular component having an interface compatible with the at least one interface. The method also involves, in response to a determination that the modular component requires installation on the host platform, causing the modular component to be installed at the at least one interface. The at least one interface including a mechanical interface having mounting features that correspond to mounting features on the modular component for removably mounting the modular component to the mechanical interface of the host platform and an signal interface for transmitting signals between the modular component and the host platform. The method further involves operating the robotic system within a worksite to perform the automated task.

The method may involve causing a processor circuit disposed on at least one of the host platform and the modular component to make the determination that the modular component requires installation on the host platform, and causing the processor circuit to communicate via a communications link with a remotely located cloud processor, the cloud processor being operably configured to initiate a fulfillment process resulting in the modular component being provided at the worksite.

The method may involve causing the processor circuit to communicate status information associated with operation of the robotic system at the worksite to the cloud processor, the cloud processor being operably configured to make the determination that the modular component requires installation on the host platform based on the status information.

Initiating the fulfillment process may involve causing cloud processor to initiate an order from a service provider to ship the modular component to the worksite.

Causing the modular component to be installed at the at least one interface may involve one of causing a cloud processor to communicate with a worker at the worksite via a communications device to direct the worker to install the modular component, and causing the cloud processor to communicate with a second robotic system at the worksite to direct the second robotic system to install the modular component.

In accordance with one disclosed aspect there is provided a robotic system for providing robotic functions associated with performing an automated task. The system includes a host platform operably configured to provide at least some of the robotic functions for performing the automated task and having at least one interface operably configured to receive a plurality of modular components, the modular components being operable to provide additional robotic functions for performing the automated task. Each modular component includes a component processor circuit disposed on the modular component and a wireless data interface operable to provide functionality for exchanging at least one of commands for performing the additional functions or data associated with the additional functions between the plurality of modular components.

The respective wireless data interfaces of the plurality of modular components may be operably configured to connect via a wireless communications link with a remotely located cloud processor, the cloud processor being operably configured to initiate act as an intermediary between the plurality of modular components. Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1 is an exploded perspective view of a robotic system for providing robotic functions according to a first disclosed embodiment;

FIG. 2A is a perspective view of a manipulator interface and manipulator of the robotic system shown in FIG. 1;

FIG. 2B is a perspective view of the manipulator interface and an alternative manipulator of the robotic system shown in FIG. 1;

FIG. 2C is a perspective view of a pair of electrical connectors associated with the manipulator interface shown in FIGS. 2A and 2B;

FIG. 3 is a block diagram of a primary processor circuit and component processor circuits implemented in the robotic system shown in FIG. 1;

FIG. 4A is a perspective view of a first configured robotic system using the components shown in FIG. 1;

FIG. 4B is a perspective view of a second configured robotic system using the components shown in FIG. 1;

FIG. 5 is a schematic view of a worksite in which the robotic system shown in FIG. 4A and FIG. 4B are deployed to perform automated tasks;

FIG. 6 is a flow chart of a process implemented at the worksite shown in FIG. 5 for servicing or reconfiguring the robotic system shown in FIG. 4A;

FIG. 7 is a flow chart of process performed by a second robotic system acting as a service unit at the worksite shown in FIG. 5;

FIG. 8A is a schematic view of the second robotic system acting as a service unit;

FIG. 8B is a further schematic view of the second robotic system removing a modular component; and

FIG. 8C is a schematic view of the second robotic system installing a replacement modular component.

### DETAILED DESCRIPTION

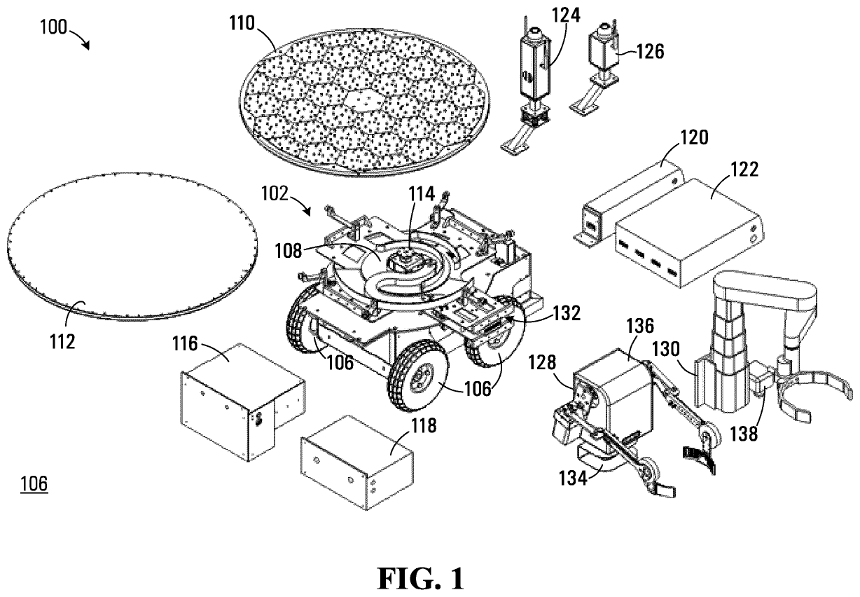

Referring to FIG. 1, a robotic system for providing robotic functions associated with performing an automated task according to a first disclosed embodiment is shown generally at 100. The robotic system 100 includes a host platform 102 operably configured to provide at least some of the robotic functions for performing the automated task. In this embodiment the host platform 102 is configured as a wheeled vehicle and the host platform 102 includes wheels 104 for moving about a worksite 106. The wheels 104 may be coupled to a main drive housed within the host platform 102 for delivering a drive force to one or more of the wheels. The host platform 102 may have further implemented functionality.

The host platform 102 also includes at least one interface configured to receive a modular component. The robotic system 100 further includes a plurality of modular components that are operable to provide additional robotic functions for performing the automated task. As an example, the host platform 102 includes a table interface 108 that receives a selected one of a pair of modular tables 110 and 112. In the embodiment shown, the tables 110 and 112 are differently configured to receive and transport articles and one of the tables may be more suitable for performing the automated task. As an example, the table 110 includes additional pin features for securely transporting articles in comparison with the table 112, which provides only a surface for receiving and securing the articles. The tables 110 or 112 are received on the table interface 108, which also includes a rotational actuator 114 for rotating the table, which is associated with the table interface 108 of the host platform 102. The rotational actuator 114 acts as an auxiliary drive on the host platform 102 for moving the table modular components 110 and 112. Other modular components may be similarly received on the host platform 102. Several other modular components are shown in FIG. 1, including modular primary processors 116 and 118, batteries 120 and 122, communication transceivers 124 and 126, and alternative manipulators 128 and 130. The interfaces may be implemented as a standardized interface associated with a group of modular components operably configured to provide similar additional robotic functions. As an example, the alternative manipulators 128 and 130 may have a common standardized interface while the batteries 120 and 122 may have a different common standardized interface. The standardization may involve standardizing on a connector for connection between the modular component and the interface.

In this embodiment the manipulator module 128 also includes a sensor 134 mounted under a housing 136 of the manipulator. Similarly the manipulator 130 includes a sensor 138 mounted on the manipulator. The sensors 134 and 138 may include proximity sensors that provide an indication of obstacles in the path of the host platform 102. In some embodiments the proximity sensor may be implemented using an optical light detection and ranging (LIDAR) sensor as described in commonly owned PCT patent application publication WO/2018/045448 entitled “MOBILE WORK STATION FOR TRANSPORTING A PLURALITY OF ARTICLES” filed on Mar. 10, 2017 and incorporated herein by reference in its entirety. Other proximity sensors such as an infrared sensor or ultrasonic sensor may be alternatively or additionally used in implementing the sensors 134 and 138.

The host platform 102 would generally include an electrical chassis for connecting between components that are part of the host platform 102 and the various modular components.

The modular components 110-130 described above represent options for implementing different functionality on the host platform 102, depending on the automated task to be performed. For example, the battery 122 may provide a higher amp-hour capacity than the battery 120, which would extend the operating time of the robotic system 100 before requiring recharging of the battery. The manipulator module 130 is configured as a selective compliance articulated robot arm (SCARA) manipulator providing improved accuracy and range of motion in comparison to the manipulator module 128, which is configured to provide a more limited range and variety of motion.

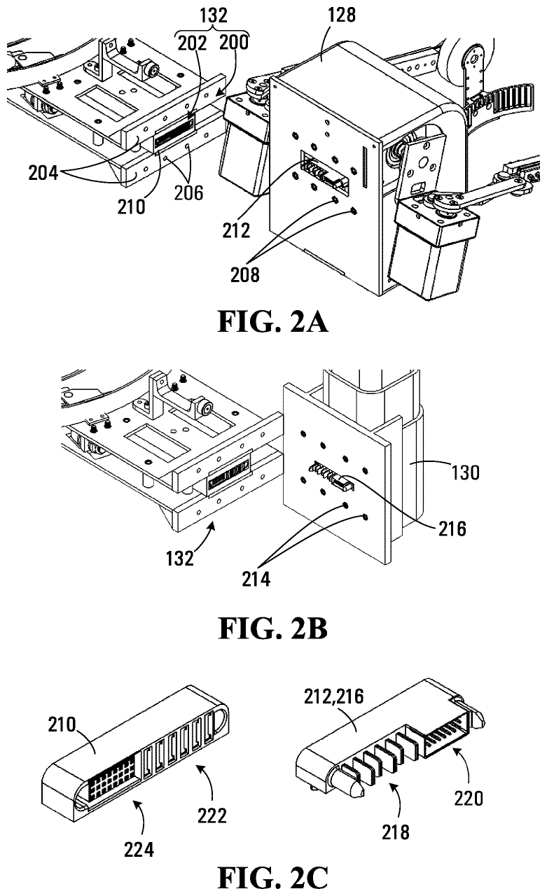

In this embodiment the host platform 102 also includes a manipulator interface 132, which in this embodiment is mounted to the table interface 108. The manipulator interface 132 and the manipulator 128 are shown in greater detail in FIG. 2A. Referring to FIG. 2A, the manipulator interface 132 includes a mechanical interface 200 and a signal interface 202. The mechanical interface 200 provides mounting features that correspond to mounting features on the manipulator 128 for removably mounting the manipulator to the host platform 102. In this embodiment the mechanical interface 200 includes a pair of mounting flanges 204 having a pattern of through holes 206. The manipulator 128 has corresponding mounting features, including a plurality of threaded holes 208 corresponding to the pattern of through holes 206 on the mechanical interface 200. Fasteners (not shown) may be inserted through the holes 206 into the corresponding threaded holes 208 on the manipulator for securing the manipulator 128 to the mechanical interface 200 of the manipulator interface 132. The signal interface 202 in this embodiment includes an electrical connector 210, which is disposed to receive and connect with a corresponding connector 212 on the manipulator 128. While in this embodiment the signal interface 202 includes the electrical connector 210, in other embodiments the modular component may have be configured to communicate wirelessly with the host platform 102 and the signal interface may be implemented as a wireless interface, such as a Bluetooth or IEEE 802.11 interface, for example.

Referring to FIG. 2B, the alternative manipulator 130 is similarly configured to include the same pattern of threaded holes 214 and electrical connector 216, facilitating replacement of the manipulator 128 by the alternative manipulator 130, when more suited to performing the automated task.

Referring to FIG. 2C, in this embodiment the electrical connectors 210 and 212 of the signal interface 202 connect both signals and power to the module. The electrical connectors 210 and 212 in this embodiment provide separated connector portions including a power/drive line connector portion 218 and a signal connector portion 220. The power/drive connector portion 218 is used for routing power and other higher current electrical lines typically associated with providing power to the manipulator 130 and for driving motors and actuators of the manipulator. Supply lines carrying higher currents are often associated with causing electromagnetic interference, which may be coupled into other signal lines or radiated as transmitted radio frequency waves (RF). The signal connector portion 220 is physically separated from the connector portion 218 and carries other signal lines that operate at low signal levels for communicating commands and data, sensor signals and data, and other signals susceptible to disturbance by electromagnetic interference. By separating the connector portions 218 and 220, the low level signals may be routed within the manipulators 128 and 130 to minimize their susceptibility to electromagnetic interference produced by the higher current drive lines associated with the connector portion 218. Similarly, the electrical connector 210 on the host platform manipulator interface 132 includes a connector portion 222 corresponding to the connector portion 218 and a connector portion 224 corresponding top the connector portion 220, to continue the physical separation between higher current lines and low signal level lines on the host platform 102. The connectors shown in FIG. 2C, are standard Molex connectors (Part number 465621003) manufactured by Molex Incorporated, Illinois, United States having 24 signal connections and 6 power connections.

In other embodiments the mechanical interface 200 may further include a mechanical coupler (not shown) for transmitting power between the host platform 102 and the modular component. As an example, the mechanical coupler may include a fluid coupling for transmitting hydraulic or pneumatic power between the host platform and the modular component. Alternatively the mechanical coupler may include a drive coupler for transmitting a torque or a force between the host platform and the modular component. As an example, a motor on the host platform 102 may be configured deliver a torque via a coupling and the modular component may have a corresponding mechanical coupling that connects to transmit the torque to the modular component.

In the embodiment shown in FIG. 1, the robotic system 100 is controlled by a modular primary processor 116 or 118 configured as a modular component and is received at a primary processor circuit interface (not shown) of the host platform 102. As such, the host platform 102 includes electrical and mechanical interfaces as described above in connection with the manipulator modules 128 and 130 that act as the primary processor circuit interface. In other embodiments the primary processor circuit may be disposed on and part of the host platform 102.

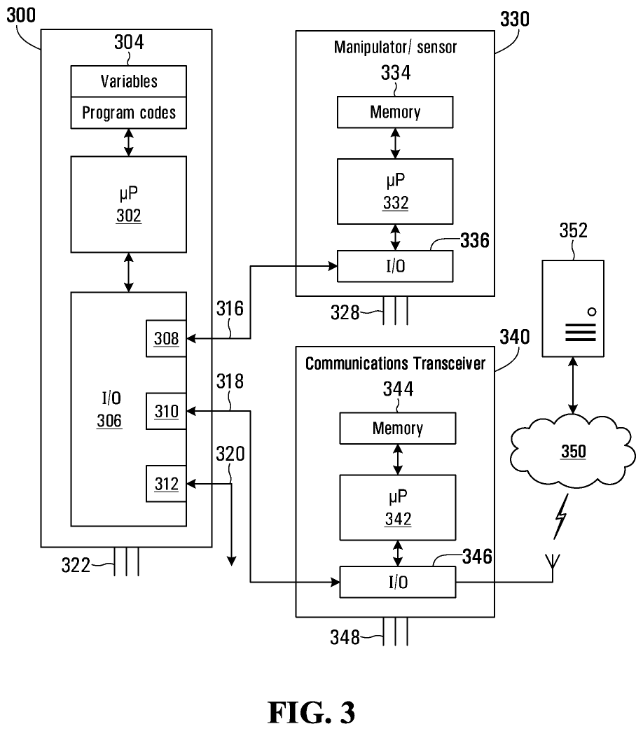

A block diagram of a processor circuit for implementing the modular primary processors 116 or 118 is shown in FIG. 3 at 300. Referring to FIG. 3, the primary processor circuit 300 includes a microprocessor 302, a memory 304, and an input/output (I/O) 306, all of which are in communication with the microprocessor 302. The 1/O 306 includes a plurality of interfaces 308, 310, and 312 for interfacing with the modular components 110-130 shown in FIG. 1. For example, the plurality of interfaces 308 and 310 may include a wired network interface (such as an Ethernet interface), a USB interface, and analog to digital converter, and/or other interface types operably configured to receive inputs from modular components and/or to send commands to the modular components. The interfaces communicate with the modular components via low level signal lines 316, 318, and 320. Higher current lines 322 provide electrical power for operating the primary processor circuit 300. The higher current signals carried by lines 322 may be physically separated from the low level signal lines 316, 318, and 320, as described above in connection with the manipulator modules 128 and 130. The primary processor circuit 300 may be implemented as an embedded processor circuit such as a Microsoft Windows® industrial PC. The modular primary processor 116 may differ from the modular primary processor 118 by providing a larger number of I/O channels or interfaces, enhanced computational power, for example.

Program codes for directing the microprocessor 302 to carry out various functions are stored in a program code location of the memory 304, which may be implemented as a flash memory, for example. The program codes direct the microprocessor 302 to implement an operating system (such as Microsoft Windows for example) and to perform various other system functions associated with operation of the robotic system 100. The memory 304 also includes variable storage locations for storing variable and parameter data associated with operation of the robotic system 100.

In the embodiment shown, the primary processor circuit 300 is in communication with a component processor circuit 330 implemented on the manipulator module 128 or 130. The component processor circuit 330 includes a microprocessor 332, a memory 334, and an input output (I/O) 336, all of which are in communication with the microprocessor 332. The 1/O 336 may be configured to implement one or more interfaces compatible with the interface 308 for receiving commands from the primary processor circuit 300 for controlling operations of the manipulator 128,130 and respective sensors 134 and 138. The component processor circuit 330 is powered via lines 328 as described above in connection with the primary processor circuit 300. As an example, the interface 308 may include a wired Ethernet interface for interfacing with the sensors 134 and 138.

The component processor circuit 330 is operably configured to implement protocols for interfacing the modular components with the primary processor circuit 300 to perform additional robotic functions. For example, the component processor circuit 330 may receive inputs from the sensor 134, 138 and other sensors associated with the manipulation of articles by the manipulator, and also respond to commands received from the primary processor circuit 300. The interface 308 and the 1/O 336 thus provide a data interface that provides functionality for exchanging commands for performing additional functions performed by the manipulator 128, 130 and data associated with these additional functions. In one embodiment computer readable instructions in the form of an application programming interface (API) may be executed on the microprocessor 302 of the primary processor circuit 300 to define and implement the interface between the processor circuits for exchanging commands and data. The API exposes functionality for interfacing between modular components and the primary processor circuit 300. Details of the API, the mechanical interface 200, and the signal interface 202 may be provided to third party developers of modular components allowing others to design components for use with the host platform 102.

The primary processor circuit 300 is also in communication with a component processor circuit 340 implemented on the communications transceiver module 124, 126. The component processor circuit 340 includes a microprocessor 342, a memory 344, and an input output (I/O) 346, all of which are in communication with the microprocessor 342. The 1/O 346 may be configured to implement one or more interfaces compatible with the interface 310 for receiving commands from the primary processor circuit 300 for controlling operations of the communications transceiver module 124, 126. As an example, the interface 310 may be implemented as a universal serial bus (USB) interface for communicating via the communications transceiver modules 124 and 126.

The component processor circuit 340 is powered via lines 348 as described above in connection with the primary processor circuit 300. The 1/O 346 further includes a wireless interface (such as an IEEE 802.11 interface) for wirelessly receiving and transmitting data communication signals between the robotic system 100 and a network 350, such as the internet. In this embodiment the component processor circuit 340 manages communications between the primary processor circuit 300 and the network 350, and facilitates communications between a cloud processor 352 and the robotic system 100. The cloud processor 352 may be implemented as a cloud server located remotely from the worksite 106. In some embodiments may be a server hosted by an on-demand cloud computing platform such as Amazon Web Services (AWS), for example. In some embodiments, the communications transceiver module 124 may provide a greater working range for use in larger worksites than the communications transceiver module 126. As in the case of the component processor circuit 330, the component processor circuit 340 may implement or make use on an API implemented by the primary processor circuit 300 to define and implement the interface between the processor circuits for exchanging commands and data.

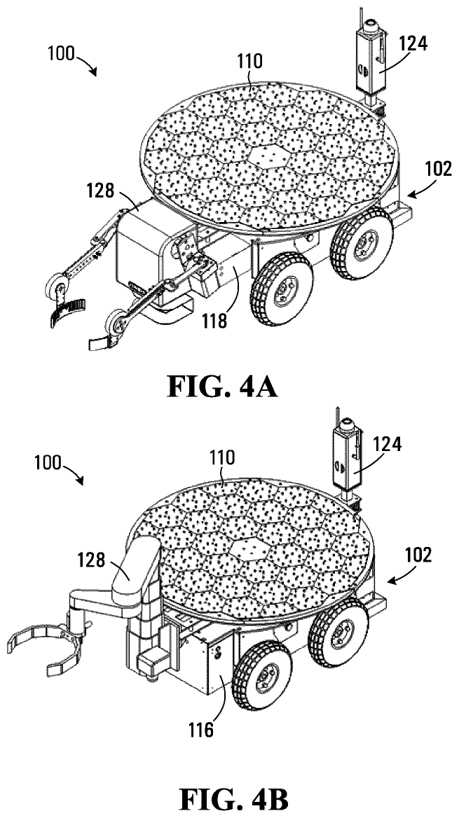

The robotic system 100 of FIG. 1 is shown assembled and configured in two differing configuration in FIG. 4A and FIG. 4B to perform different automated tasks. Referring to FIG. 4A, the robotic system 100 has the manipulator 128 and primary processor 118 received on the host platform 102. Referring to FIG. 4B, the robotic system 100 has the alternative manipulator 130 and primary processor 116 received on the host platform 102. Other modules such as the table 110 and transceiver 124 are common to both depicted embodiments of the robotic system 100.

Other modular components such as the batteries 120 and 122 may not have a component processor circuit implemented and may be interfaced via the interface 312. In one embodiment the interface 312 may be configured as an analog to digital converter operable to receive analog signals from components such as the batteries 120 and 122 representing operating conditions such as a state of charge and/or temperature of the battery. The analog signals would then be converted into digital data representations by the interface 312 and may be monitored by the primary processor circuit 300. In the case of the table 110, as disclosed in commonly owned PCT patent application PCT/CA2019/000022, entitled “APPARATUS FOR SUPPORTING AN ARTICLE DURING TRANSPORT, filed on Feb. 14, 2019, and incorporated herein by reference in its entirety, the table may have include a processor circuit acting as a component processor circuit that provides information related to the positioning of articles on the table. Other table embodiments may not be configured to provide such information and the interface may thus only include the mechanical interface aspects described above.

The embodiment shown in FIG. 1 is described as including only two modular components of each type, however in practice there may be more or less modular component options of each type. Additionally, in some cases the modular components of any type may have identical specifications where the component is subject to malfunction and may need to be replaced with an identical modular component. Modular components of each specific type may be received at specific standardized interfaces that conform with an interface specification defining physical characteristics of the mechanical interface and signal interface, as well as specifications related to the power supply lines, drive lines, signals, and communication protocols associated with the signal interface and/or API's implemented by the processor circuits.

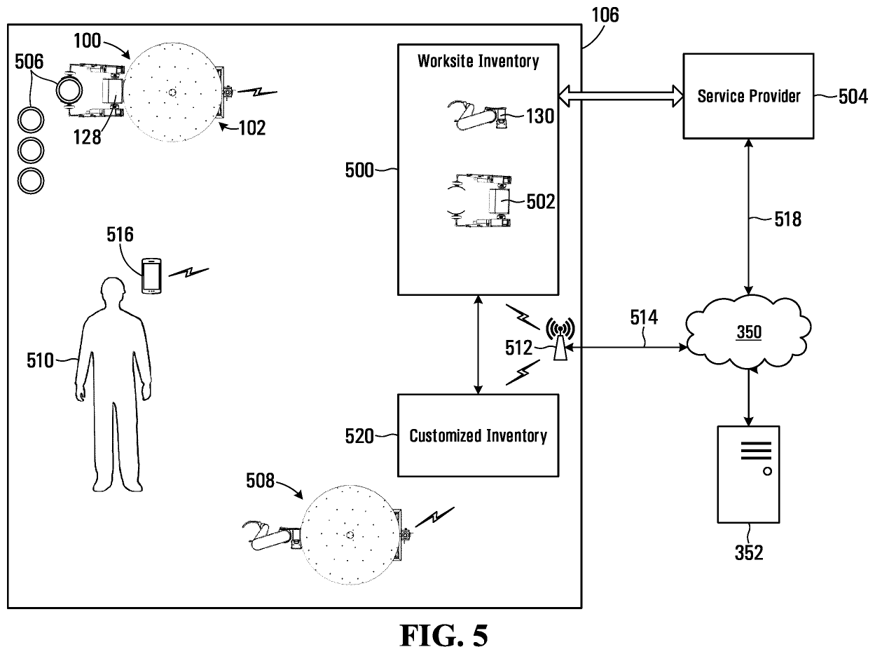

The host platform 102 and modular components 110-130 described above and configured as shown in FIG. 4A or 4B may be deployed in the worksite 106. Referring to FIG. 5, the worksite 106 is shown schematically and further includes a worksite inventory 500, which in this embodiment is shown having the SCARA manipulator module 130 and a spare manipulator module 502 corresponding to the manipulator module 128 on the robotic system 100. An external service provider 504 is located outside of the worksite 106 and is set up to be able to cause additional modular components to the worksite inventory 500. In some embodiments the service provider may be the vendor of the host platform 102 or may be another vendor that provides modular components for use with the host platform. In other embodiments there may be a plurality of different service providers capable of supplying modular components to the worksite 106.

In the embodiment shown, the cloud processor 352 (shown in FIG. 3) is disposed remotely to the worksite 106, and in some embodiments may provide service to a plurality of different worksites. As an example, the cloud processor 352 may be operated by a vendor of the host platform 102. The robotic system 100 is shown performing an automated task of moving and arranging articles 506 within the worksite 106. A second robotic system 508 is also deployed at the worksite 106. A human worker 514 is also present at the worksite 106.

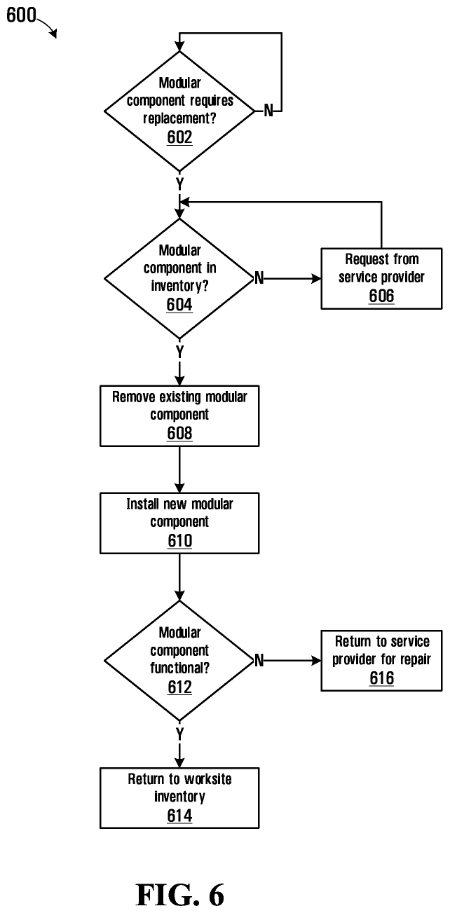

A process implemented at the worksite 106 for servicing or reconfiguring the robotic system 100 is shown as a flowchart in FIG. 6 at 600. Referring to FIG. 6, the process 600 starts at 602, where a determination is made as to whether a modular component requires replacement. The determination may be made by the primary processor circuit 300 of the robotic system 100 detecting a fault in the manipulator module 128 of the robotic system 100. Alternatively, the robotic system 100 may be directed to perform an automated task that requires a different manipulator, such as the SCARA manipulator 130. If there is no determination made at 602, then the process remains suspended. If a modular component requires replacement, then the process 600 continues at 604, where a determination is made as to whether the necessary replacement modular component is in the worksite inventory 500. If not in the worksite inventory 500, a request is placed to the external service provider 504 to provide the modular component. In the embodiment shown the worker 510 may arrange for the request to the external service provider 504 for the required modular component. The process would then be suspended at 604, until the required modular component is in the worksite inventory 500, before the process resumes at 608. The worker 510 may be a trained robotic system technician, but may also have no specialized knowledge of robotics. The process continues at 608 and the worker 510 removes the existing manipulator module 128 from the robotic system 100 by disengaging the mechanical interface 200 and signal interface 202. The worker 510 also obtains the replacement module from the worksite inventory 500 (such as the SCARA manipulator 130 from the worksite inventory). In the example shown in FIG. 5, the manipulator module 128 may be replaced at 610 by installing the SCARA manipulator 130. The replacement is facilitated by the standardized mechanical interface 200 and signal interface 202 of the host platform 102, facilitating efficient replacement by a relatively low skill worker not specifically trained in robotics. Once the manipulator 130 is installed on the host platform 102, the robotic system 100 may recognize the module via the API associated with the interface 308, and complete system configuration for the installed module. The process 600 then continues at 612, where a determination is made as to whether the removed module is functional. If the replacement of the manipulator module 128 was to enhance the functionality of the robotic system 100 rather than to address a failure of the manipulator, then the removed module is likely functional and is returned to the worksite inventory 500. If however a modular component was replaced due to failure, the removed module would be returned to the applicable external service provider 504 for repair or replacement. The external service provider 504 may be requested to replenish the worksite inventory 500 by providing a replacement unit to replace the failed modular component.

Referring back to FIG. 5, the robotic system 100 includes the communications transceiver module 124 that facilitates communication between the robotic system and the cloud processor 352 via the network 350. In one embodiment the worksite 106 includes a wireless access point 512 in communication with the network 350 via a wired connection 514. The communications transceiver module 124 of the robotic system 100 is thus able to connect to the cloud processor 352 via the wireless access point 512 and network 350. The second robotic system 508 and the worksite inventory 500 are also able to connect to the cloud processor 352 via the wireless access point 512 and network 350. The worker 510 carries a communications device 516 such as a smartphone or tablet computer and is able to connect to the cloud processor 352. The external service provider 504 is also connected to the network 350 via a wired connection 518. In other embodiments, the robotic systems 100, 508, the communications device 514, and the worksite inventory 500 may connect to the cloud processor 352 via a cellular data network and the worker 510.

In one embodiment the cloud processor 352 is operable to receive status information from the worksite 106 and/or the external service provider 504. For example, the robotic systems 100 and 508 may have their respective primary processor circuits operably configured to monitor operations and provide status information to the cloud processor 352 on an ongoing basis. Such status information may include information defining currently installed modules, battery capacity, fault information, etc. Similarly, the worksite inventory 500 may keep an inventory list of currently available modular components and may update the cloud processor 352 when there is a change in inventory. The external service provider 504 may similarly share inventory information and may also accept requests to provide additional modules to the worksite 106 via the network 350. In some embodiments the cloud processor 352 may also receive information about the worker 510 via their communications device 516, for example by confirming availability and/or sharing their location within the worksite 106.

In some embodiments the cloud processor 352 may be configured to manage aspects of operations for the service provider 504 in performing predictive maintenance on the robotic systems 100 and 508. For example, the cloud processor 352 may record usage data for any of the modular components 110-130 (shown in FIG. 1) and based on specifications, lifetime data, or other past experience with the modular components, may determine that a module requires replacement to avoid potential failure during operations. Failure of a modular component during operations of the robotic system 100 is may disrupt workflow and would be better attended to before failure occurs. The cloud processor 352 may alert the worker 510 via the communications device 516 that a modular component such as the manipulator module 128 on the robotic system 100 requires replacement. As such this may involve the worker 510 receiving an alert from the cloud processor 352 at their communications device 516 at 602 of the process 600, and the remainder of the process may be executed. At the step 604 of the process 600, the cloud processor 352 would make the determination of whether the modular component was in the worksite inventory 500, and if not would place the request at 606 to the external service provider 504. Similarly, the cloud processor 352 could execute the steps at 612 to either have the modular component that was removed returned to worksite inventory 500 or to the external service provider 504 as applicable. The cloud processor 352 may additionally monitor and assess the functionality of modular components 110-130 and communicate with the external service provider 504 to indicate potential areas of optimization or improvement. The external service provider 504 may then use the information to produce and/or deliver improved modular components to the worksite 106 to improve functionality. Similarly, the external service provider 504 may provide information to the cloud processor 352 of required upgrades to hardware or software of modular components deployed at the worksite 106 and the cloud processor 352 would take on the management of these upgrades by identifying the affected modular components at the worksite and arranging to have them returned for service, or in some cases such as a software upgrade, arranging to have the upgrade performed at the worksite 106.

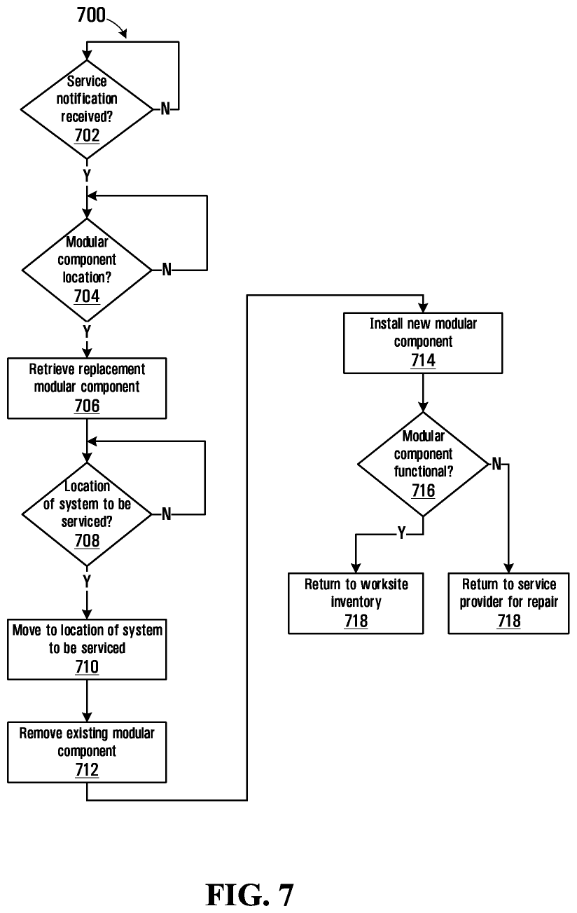

Still referring to FIG. 5, in one embodiment the second robotic system 508 may be designated as a robotic service unit for the worksite 106. The designated role of service unit may be either a temporary designation for the robotic system 508, or in some cases where multiple robotic systems operate at a worksite, a robotic system may be permanently designated and configured to perform this role. A process performed by the second robotic system 508 when acting as a service unit is shown in FIG. 7 at 700. Referring to FIG. 7, the process begins at 702, where the robotic system 508 determines whether a service notification has been received (for example associated with the robotic system 100). The service notification may be received from the cloud processor 352 acting on information received from the robotic system 100 or in some embodiments the service notification may be received from the robotic system 100 directly transmitted to the second robotic system 508 via the communications transceiver module 124. At 704, the robotic system 508 determines a location of a replacement modular component from the service notification. For example, if the service is being managed by the cloud processor 352 the replacement modular component may have already been verified to be in the worksite inventory 500 or will have been requested from the external service provider 504. Once the robotic system 508 determines the location of the replacement modular component, at 706 the robotic system retrieves the component, for example from the worksite inventory 500. At 708, the robotic system 508 determines the location of the robotic system 100 that is the target of the service notification and at 710 moves to the location. The primary processor circuit of the robotic system 508 is operably configured to navigate through the worksite 106 using sensors and other navigational aids as described in as described in commonly owned PCT patent application publication WO/2018/045448 entitled “MOBILE WORK STATION FOR TRANSPORTING A PLURALITY OF ARTICLES” filed on Mar. 10, 2017 and incorporated herein by reference in its entirety.

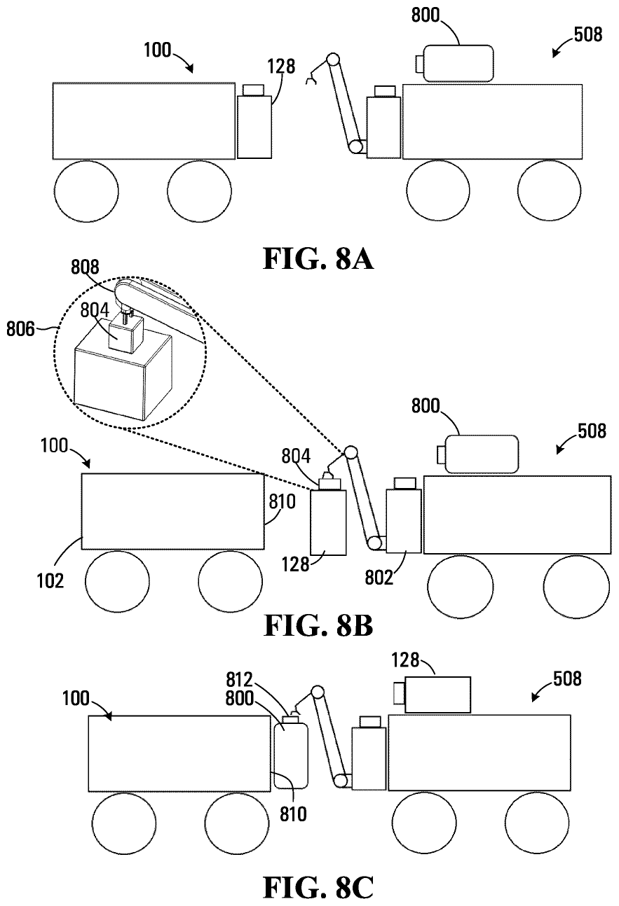

Referring to FIG. 8A, the robotic system 508 is shown having located the robotic system 100. The robotic system 100 has the manipulator module 128 installed. The robotic system 508 is carrying a replacement modular component 800, which is to replace the manipulator module 128 on the robotic system 100. In this embodiment the robotic system 508 is of a generally similar configuration to the robotic system 100, but in other embodiments may be specifically configured for performing a service role.

Referring to FIG. 8B, the robotic system 508 includes its own manipulator 802 and is able to grasp the manipulator module 128 on the robotic system 100 and remove the modular component from the system. Referring back to FIG. 7, the process 700 then continues at 712, where the existing manipulator module 128 of the robotic system 100 is removed by the manipulator 802 of the robotic system 508. In the embodiment shown in FIG. 8B, the modular component 800 includes a common coupler 804 operably configured to facilitate handling of the modular component by the manipulator 802 of the robotic system 508. As shown in the insert 806, an end effector 808 of the robotic system 508 is configured to engage features of the common coupler 804 for holding and mounting the modular component 800 at an applicable interface 810 on the host platform 102 of the robotic system 100. The removed manipulator module 128 is placed on the table of the robotic system 508, and the process 700 continues at 714 with the installation of the new modular component 800.

Referring to FIG. 8C, the replacement modular component 800 also includes a common coupler 812, and the robotic system 508 grasps the modular component using the end effector 808. The replacement modular component 800 is then installed onto the interface 810 of the host platform 102.

Referring back to FIG. 7, the process 700 then continues at 716 where the robotic system 508 makes a determination (based on the service notification) of whether the modular component 128 is functional. If functional the component will be returned to the worksite inventory 500 by the robotic system 508. If not functional the component will be returned to the external service provider 504 via worksite inventory 500.

Referring back to FIG. 5, in the embodiment shown the worksite 106 also includes a customized inventory capability 520 for producing modular components or portions of modular components customized for the worksite. As an example, the customized inventory capability 520 may include a 3D printer that communicates with the cloud processor 352 to obtain component design files that can be printed to produce components specifically customized for the worksite 106. The customized modular components may be placed in the worksite inventory 500 for use at the worksite 106.

In some embodiments, the cloud processor 352 may act as an intermediary for communications between the primary processor circuit 300 and the modular component or between different modular components. For example, a modular component may have a wireless communications capability, facilitating direct communication between the cloud processor 352 via the network 350. The cloud processor 352 may be configured to receive data signals from the modular component and to process and/or direct these signals back to the primary processor circuit 300 on the host platform 102. The communication between the primary processor circuit 300 on the host platform 102 and the modular component may thus be channeled through the cloud processor 352.

In some embodiments that modular component may share status information directly with the cloud processor 352 via the network 350 and the cloud processor may be operably configured to process this information. For example, the cloud processor 352 may initiate a fulfillment process to have the modular component replaced when a fault or imminent failure is detected by the cloud processor based on the received status data. Where different modular components on the host platform 102 are each equipped with a wireless interface, the components may communicate information without the involvement of the host platform 102 or the primary processor circuit 300. In cases where the implemented interfaces on the modular components are compatible the communication may be directly conducted between the modules. In other embodiment, the communications may be conducted using the cloud processor 352 as an intermediary.

While specific embodiments have been described and illustrated, such embodiments should be considered illustrative only and not as limiting the disclosed embodiments as construed in accordance with the accompanying claims.

What is claimed is:

1. A robotic system for providing robotic functions associated with performing an automated task, the system comprising:
a host platform operably configured to provide at least some of the robotic functions for performing the automated task and having at least one interface operably configured to receive a modular component, the modular component being operable to provide additional robotic functions for performing the automated task;
a processor circuit disposed on at least one of the host platform and the modular component; and
wherein the at least one interface comprises:
a mechanical interface having mounting features that correspond to mounting features on the modular component for removably mounting the modular component to the mechanical interface of the host platform;
a signal interface for transmitting signals between the modular component and the host platform; and
a data interface implemented on the processor circuit and operable to provide functionality for exchanging at least one of commands for performing the additional functions or data associated with the additional functions between the modular component and the processor circuit.

2. The system of claim 1 wherein the signal interface comprises one or more connectors that facilitate connection of signal lines for communicating between the processor circuit and the robotic system.

3. The system of claim 2 wherein the electrical connector comprises:
a signal connector portion for connecting low level electrical signals and data lines between the host platform and the modular component; and
a power/drive connector portion for connecting higher current lines between the host platform and the modular component; and
wherein the signal connector portion and the power/drive connector portion are separated to reduce effects of electromagnetic interference on the low level electrical signals and data lines.

4. The system of claim 1 wherein the processor circuit comprises a primary processor circuit operably configured to control functions of the host platform and the modular component, and further comprising a component processor circuit disposed on the modular component and operably configured to interface with the primary processor circuit via the data interface to perform the additional robotic functions.

5. The system of claim 4 wherein the primary processor circuit is configured as a modular component and is received at a primary processor circuit interface on the host platform.

6. The system of claim 1 wherein the mechanical interface further comprises a mechanical coupler for transmitting power between the host platform and the modular component.

7. The system of claim 6 wherein the mechanical coupler comprises at least one of:
a fluid coupling for transmitting hydraulic power between the host platform and the modular component;
a fluid coupling for transmitting pneumatic power between the host platform and the modular component; and
a drive coupler for transmitting one of a torque or a force between the host platform and the modular component.

8. The system of claim 1 wherein the signal interface comprises a wireless signal interface.

9. The system of claim 8 wherein the data interface between the processor circuit and the modular component is via a wireless communications link with a remotely located cloud processor, the cloud processor being operably configured to initiate act as an intermediary between the processor and the modular component.

10. The system of claim 1 wherein the robotic functions provided by the host platform are provided by components mounted directly on the host platform, the components comprising at least one of:
a primary processor circuit operably configured to control functioning of the host platform and the at least one modular component;
a main drive operably operable to position the host platform within a worksite for performing robotic tasks;
an auxiliary drive operable to act as a mechanical interface for mounting a moveable modular component; and
an electrical chassis for routing electrical connections between the interface and the host platform.

11. The system of claim 1 wherein the modular component comprises one of a plurality of modular manipulator components, each modular manipulator component having:
a common component interface corresponding to the host platform interface; and
one of a plurality of different manipulators operably configured to perform different manipulator functions for performing the automated task.

12. The system of claim 1 wherein the modular component comprises at least one of:
a power storage device operable to provide power for operating the robotic system;
a communication device operably configured for at least one of receiving data or transmitting data between the robotic system and a host controller; and
a structure for receiving and supporting articles for transport within a worksite.

13. The system of claim 1 wherein the modular component includes a common coupler operably configured to facilitate handling of the modular component by a manipulator of a robotic system, the robotic system having an end effector operably configured to engage the common coupler for mounting the modular component at the interface on the host platform.

14. The system of claim 13 wherein the common coupler comprises standardized features added to each of a plurality of different modular components to facilitate handling by single standardized end effector of the robotic system.

15. The system of claim 13 wherein the manipulator is associated with one of:
another robotic system other than the robotic system having the modular component being mounted, the other robotic system being operably configured to handle and install the modular component; and
a functioning manipulator of the robotic system having the modular component being mounted, wherein the functioning manipulator is operable to handle and install the modular component.

16. The system of claim 1 wherein the interface comprises a standardized interface associated with a group of modular components operably configured to provide similar additional robotic functions.

17. The system of claim 16 wherein the signal interface comprises a connector standardized for connection to modular components that provide the similar additional robotic functions.

18. A method of operating a robotic system for performing an automated task, the robotic system including a host platform operably configured to provide at least some of the robotic functions for performing the automated task and having at least one interface operably configured to receive a modular component, the modular component being operable to provide additional robotic functions for performing the automated task;
providing a modular component having an interface compatible with the at least one interface;
in response to a determination that the modular component requires installation on the host platform, causing the modular component to be installed at the at least one interface, the at least one interface including a mechanical interface having mounting features that correspond to mounting features on the modular component for removably mounting the modular component to the mechanical interface of the host platform and an signal interface for transmitting signals between the modular component and the host platform; and
operating the robotic system within a worksite to perform the automated task.

19. The method of claim 18 further comprising:
causing a processor circuit disposed on at least one of the host platform and the modular component to make the determination that the modular component requires installation on the host platform; and
causing the processor circuit to communicate via a communications link with a remotely located cloud processor, the cloud processor being operably configured to initiate a fulfillment process resulting in the modular component being provided at the worksite.

20. The method of claim 19 further comprising causing the processor circuit to communicate status information associated with operation of the robotic system at the worksite to the cloud processor, the cloud processor being operably configured to make the determination that the modular component requires installation on the host platform based on the status information.

21. The method of claim 20 wherein initiating the fulfillment process comprises causing cloud processor to initiate an order from a service provider to ship the modular component to the worksite.

22. The method of claim 18 wherein causing the modular component to be installed at the at least one interface comprises one of:
causing a cloud processor to communicate with a worker at the worksite via a communications device to direct the worker to install the modular component; and
causing the cloud processor to communicate with a second robotic system at the worksite to direct the second robotic system to install the modular component.

23. A robotic system for providing robotic functions associated with performing an automated task, the system comprising:
a host platform operably configured to provide at least some of the robotic functions for performing the automated task and having at least one interface operably configured to receive a plurality of modular components, the modular components being operable to provide additional robotic functions for performing the automated task;
wherein each modular component comprises a component processor circuit disposed on the modular component and a wireless data interface operable to provide functionality for exchanging at least one of commands for performing the additional functions or data associated with the additional functions between the plurality of modular components.

24. The system of claim 23 wherein the respective wireless data interfaces of the plurality of modular components are operably configured to connect via a wireless communications link with a remotely located cloud processor, the cloud processor being operably configured to initiate act as an intermediary between the plurality of modular components.
